(19) United States
(12) Patent Application Publication
(10) Pub. No.: US 2021/0382954 A1
(43) Pub. Date: Dec. 9, 2021

(54) SYSTEMS AND METHODS FOR CONNECTING TO PEOPLE WITH REQUESTED SKILLSETS

(71) Applicant: Citrix Systems, Inc., Ft. Lauderdale, FL (US)

(72) Inventors: Xiaolu Chu, Nanjing (CN); Dan Hu, Nanjing (CN)

(73) Assignee: Citrix Systems, Inc., Ft. Lauderdale, FL (US)

(21) Appl. No.: 16/929,285

(22) Filed: Jul. 15, 2020

Related U.S. Application Data
(63) Continuation of application No. PCT/CN2020/095109, filed on Jun. 9, 2020.

(51) Int. Cl. G06F 16/9535; G06Q 10/10; G06N 20/00; G06N 20/20; H04L 29/08

(52) U.S. Cl. CPC G06F 16/9535; G06Q 10/105; H04L 67/18; G06N 20/20; H04L 67/306; G06N 20/00

(57) ABSTRACT

A computer system is provided. The computer system includes a memory and at least one processor coupled to the memory and configured to query a user profiling system with a skillset provided by a requestor and identify a target user that is associated with the skillset based on the query results. The at least one processor is further configured to identify a network path linking the requestor with the target user. The network path includes one or more links between nodes of a user network, the nodes associated with users including the requestor, the target user, and other users. The at least one processor is further configured to identify a preferred communication channel associated with the target user and/or the other users, based on the query results, and to provide a recommendation to the requester, the recommendation comprising the target user, the preferred communication channel, and the network path.

### RELATED APPLICATIONS

This application claims the benefit under 35 U.S.C. § 120 as a continuation of PCT application no. PCT/CN2020/095109 titled SYSTEMS AND METHODS FOR CONNECTING TO PEOPLE WITH REQUESTED SKILLSETS, filed on Jun. 9, 2020, which designates the United States. The content of the aforementioned application is hereby incorporated herein by reference in its entirety.

### BACKGROUND

Many organizations and companies have access to an extensive pool of talented employees, each possessing specific technical skills and areas of expertise. It can often be difficult, however, to locate the right person for the job, whether for consultation on a project or to head up a new initiative. One reason for this is that an employee's skills are often known only locally and are not widely visible across the company. This is particularly true in larger organizations that have many departments or divisions which can be spread out over large geographical areas of a country or throughout the world.

### SUMMARY

In at least one example, a computer system is provided. The computer system includes a memory; and at least one processor coupled to the memory and configured to: query a user profiling system with a skillset provided by a requestor; identify a target user based on results of the query, the target user associated with the skillset; identify a network path linking the requestor with the target user, the network path comprising one or more links between nodes of a user network, the nodes associated with users, the users including the requestor, the target user, and one or more other users; identify a preferred communication channel associated with the target user and/or the one or more other users, based on the results of the query; and provide a recommendation to the requester, the recommendation comprising the target user, the preferred communication channel, and the network path.

At least some examples of the computer system can include one or more of the following features. The at least one processor is further configured to: extract user features based on monitoring one or more of communications between the users, communication methods employed by the users, documents accessed by the users, and work activities of the users; create a database of the extracted user features; and apply machine learning techniques to the database to generate the user profiling system. The at least one processor is further configured to determine locations of the users for inclusion in the database and to determine organization chart relationships between the users for inclusion in the database. The machine learning techniques comprise Random Forest classification or K-means clustering. The at least one processor is further configured to calculate connectivity costs associated with the links of the user network. The at least one processor is further configured to calculate the connectivity costs based on one or more of a physical distance between the users, a measure of a working relationship between the users, and a measure of messaging frequency between the users. The at least one processor is further configured to identify the network path based on minimization of a sum of the connectivity costs associated with the links between the requestor and the target user.

In at least one example, a method for connecting to users with requested skills is provided. The method includes querying, by a computer system, a user profiling system with a skillset provided by a requestor; identifying, by the computer system, a target user based on results of the query, the target user associated with the skillset; identifying, by the computer system, a network path linking the requestor with the target user, the network path comprising one or more links between nodes of a user network, the nodes associated with users, the users including the requestor, the target user, and one or more other users; identifying, by the computer system, a preferred communication channel associated with the target user and/or the one or more other users, based on the results of the query; and providing, by the computer system, a recommendation to the requester, the recommendation comprising the target user, the preferred communication channel, and the network path.

At least some examples of the method can include one or more of the following features. The act of extracting user features based on monitoring one or more of communications between the users, communication methods employed by the users, documents accessed by the users, and work activities of the users; creating a database of the extracted user features; and applying machine learning techniques to the database to generate the user profiling system. The act of determining locations of the users for inclusion in the database and determining organization chart relationships between the users for inclusion in the database. The machine learning techniques comprise Random Forest classification or K-means clustering. The act of calculating connectivity costs associated with the links of the user network. The act of calculating calculate the connectivity costs based on one or more of a physical distance between the users, a measure of a working relationship between the users, and a measure of messaging frequency between the users. The act of identifying the network path based on minimization of a sum of the connectivity costs associated with the links between the requestor and the target user.

In at least one example, a non-transitory computer readable medium storing executable sequences of instructions to connect to users with requested skills is provided. The sequences of instructions include instructions to: query a user profiling system with a skillset provided by a requestor; identify a target user based on results of the query, the target user associated with the skillset; identify a network path linking the requestor with the target user, the network path comprising one or more links between nodes of a user network, the nodes associated with users, the users including the requestor, the target user, and one or more other users; identify a preferred communication channel associated with the target user and/or the one or more other users, based on the results of the query; and provide a recommendation to the requester, the recommendation comprising the target user, the preferred communication channel, and the network path.

At least some examples of the non-transitory computer readable medium can include one or more of the following features. Instructions to extract user features based on monitoring one or more of communications between the users, communication methods employed by the users, documents accessed by the users, and work activities of the users; create a database of the extracted user features; and apply machine learning techniques to the database to generate the user profiling system. Instructions to determine locations of the users for inclusion in the database and to determine organization chart relationships between the users for inclusion in the database. The machine learning techniques comprise Random Forest classification or K-means clustering. Instructions to calculate connectivity costs associated with the links of the user network. Instructions to calculate the connectivity costs based on one or more of a physical distance between the users, a measure of a working relationship between the users, and a measure of messaging frequency between the users. Instructions to identify the network path based on minimization of a sum of the connectivity costs associated with the links between the requestor and the target user.

Still other aspects, examples, and advantages of these aspects and examples, are discussed in detail below. Moreover, it is to be understood that both the foregoing information and the following detailed description are merely illustrative examples of various aspects and features and are intended to provide an overview or framework for understanding the nature and character of the claimed aspects and examples. Any example or feature disclosed herein can be combined with any other example or feature. References to different examples are not necessarily mutually exclusive and are intended to indicate that a particular feature, structure, or characteristic described in connection with the example can be included in at least one example. Thus, terms like “other” and “another” when referring to the examples described herein are not intended to communicate any sort of exclusivity or grouping of features but rather are included to promote readability.

### BRIEF DESCRIPTION OF THE DRAWINGS

Various aspects of at least one example are discussed below with reference to the accompanying figures, which are not intended to be drawn to scale. The figures are included to provide an illustration and a further understanding of the various aspects and are incorporated in and constitute a part of this specification but are not intended as a definition of the limits of any particular example. The drawings, together with the remainder of the specification, serve to explain principles and operations of the described and claimed aspects. In the figures, each identical or nearly identical component that is illustrated in various figures is represented by a like numeral. For purposes of clarity, not every component may be labeled in every figure.

FIG. 1 is a top-level block diagram of an implementation of a system for connecting to people with requested skillsets, in accordance with an example of the present disclosure.

FIG. 2 is a block diagram of the system for connecting to people with requested skillsets, in accordance with an example of the present disclosure.

FIG. 3 illustrates the building and updating of a user profiling system, in accordance with an example of the present disclosure.

FIG. 4 illustrates the building and updating of a user network, in accordance with an example of the present disclosure.

FIG. 5 illustrates a table of user features and a table of user connections, in accordance with an example of the present disclosure.

FIG. 6 illustrates path costs associated with links between user nodes, in accordance with an example of the present disclosure.

FIG. 7 illustrates recommendations generated by the system for connecting to people with requested skillsets, in accordance with an example of the present disclosure.

FIG. 8 is a flow diagram of a process for connecting to people with requested skillsets, in accordance with an example of the present disclosure.

FIG. 9 is a block diagram of a computing platform configured to perform a process for connecting to people with requested skillsets, in accordance with an example of the present disclosure.

### DETAILED DESCRIPTION

As noted previously, in many organizations it can be difficult to identify and utilize a person (or persons) possessing a desired skill set for a project of interest. One reason for this is that an employee's skills are often known only locally, for example within a department, and are not widely visible across the company. This is particularly true in larger organizations that have many departments or divisions which can be spread out over a large geographical area or throughout the world. Another problem is that even if an employee is identified as possessing the required skills, it can be difficult to reach out to that person directly. In a large company it may be necessary to traverse up and down many layers of a chain of command embodied in a hierarchical organization chart, with potential difficulties encountered at each layer.

To address these problems, and as summarized above, various examples described herein are directed to systems and methods for connecting to people with requested skillsets in a relatively automated fashion, for example as part of a computer network workspace. In some examples, the activities of users in this workspace are monitored and a profile of the users is created and updated over time. In some examples, the activities may include projects that the users work on, tools and applications that the users employ, documents that the users generate, documents that the users read, web pages that the user visits, and communications between the user and other users. Monitoring of communications can provide insight into not only the technical skills of the users, but also the best communication channels (and applications) to be employed to contact those users. Features are extracted from the monitoring results and machine learning techniques are applied to those features to generate a user profiling system that can be queried to identify targeted users with skillsets of interest, as will be described in greater detail below. Skillsets may include any topic, such as, for example, machine learning, Java, user interface design, web design, Bigdata, to name just a few.

In some examples, a network of users is also created and updated over time. The network comprises links between users and provides an associated connectivity cost for each link that is based on factors such as physical distance, working relationships, and extent of communication between the users. The network may be used to find the best (e.g., minimum cost) path between a requestor and a target user having the desired skillset. For example, a best path between the requestor and the target user may not be the direct path, but rather a path going through one or more intermediate users or liaisons, as will also be explained in greater detail below.

For example, a manager is starting a new project and requires someone with skills in Java and Bigdata, but such a person is not available in the manager's group. The manager can query the user profiling system and obtain recommendations that include the identities of individuals possessing those skills, and the best way to reach them, either directly or through intermediaries, as well as the communication channels or applications that would be most effective for this purpose.

As will be understood in view of this disclosure, the systems and methods for connecting to people with requested skillsets provided herein have several advantages over existing methods which rely on word of mouth or manual searching techniques which are inefficient and unreliable. For instance, the systems and methods described herein can potentially identify the skillsets of every employee in even the largest organizations, including users that are so far removed from the requestor that they would otherwise be inaccessible.

Examples of the methods and systems discussed herein are not limited in application to the details of construction and the arrangement of components set forth in the following description or illustrated in the accompanying drawings. The methods and systems are capable of implementation in other examples and of being practiced or of being carried out in various ways. Examples of specific implementations are provided herein for illustrative purposes only and are not intended to be limiting. In particular, acts, components, elements and features discussed in connection with any one or more examples are not intended to be excluded from a similar role in any other examples.

### Connection System

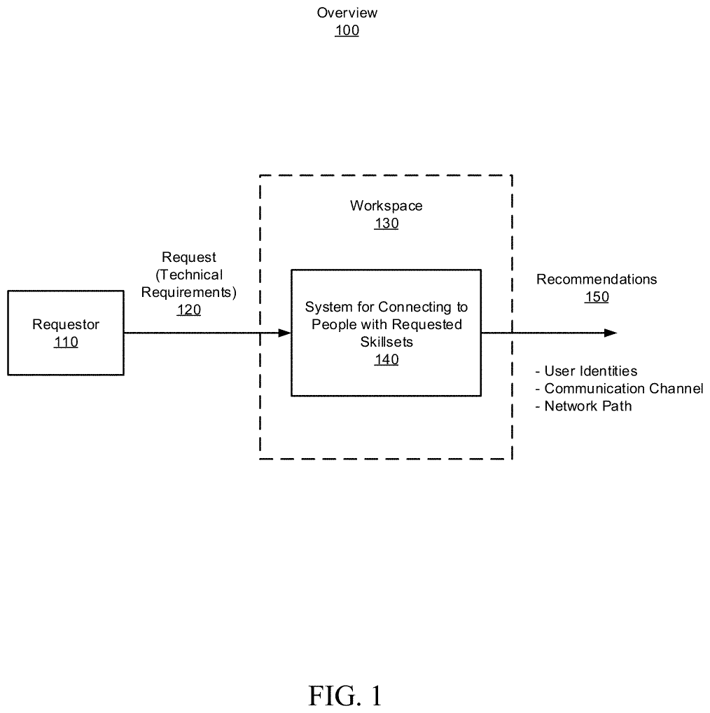

FIG. 1 is a top-level block diagram 100 of an implementation of a system 140 for connecting to people with requested skillsets, in accordance with an example of the present disclosure. As shown, a requestor 110, for example a manager of a project within in an organization, makes a request 120 of the system 140. The requestor may have a requirement for people that possess certain desired technical skills. The request 120 may specify these technical skills and any other characteristics that the requestor seeks. The system 140 generates recommendations 150 that include the identities of targeted users (e.g., employs of the organization) that possess the requested skills. The recommendations may also include a network path that can specify any number of intermediate users that could facilitate communication between the requester and the targeted user as well as a preferred communication channel (e.g., messaging applications, email applications, etc.) for the targeted user or any of the intermediate users. The recommendations are generated based on a user profiling system and a user network, the operations of which will be explained in greater detail below. The requester, the targeted user, and any intermediate users in the network path, may all be users of a computer network workspace 130 that facilitates sharing of applications, data, and other computing resources within the organization.

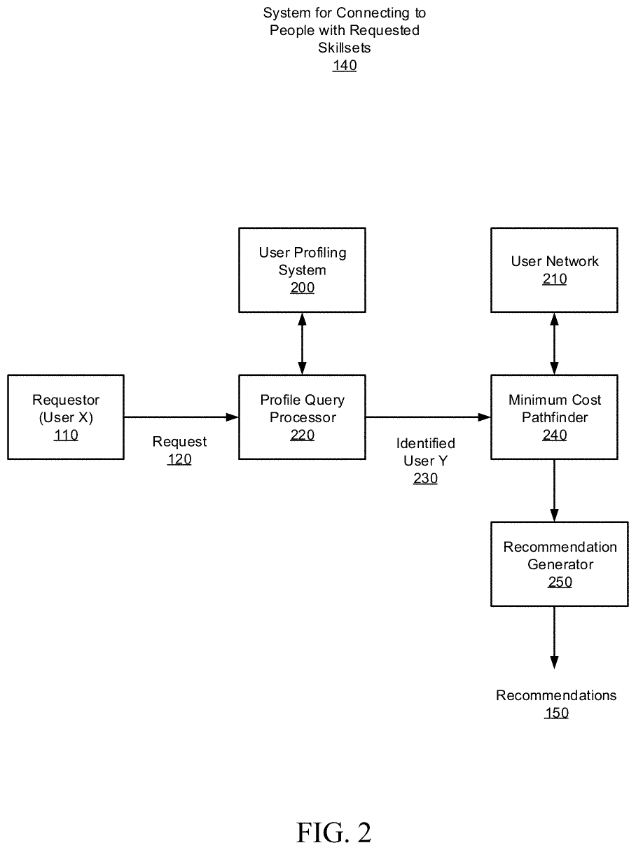

FIG. 2 is a block diagram of the system 140 of FIG. 1, for connecting to people with requested skillsets, in accordance with an example of the present disclosure. The system 140 is shown to include a user profiling system 200, a user network 210, a profile query processor 220, a minimum cost pathfinder 240, and a recommendation generator 250.

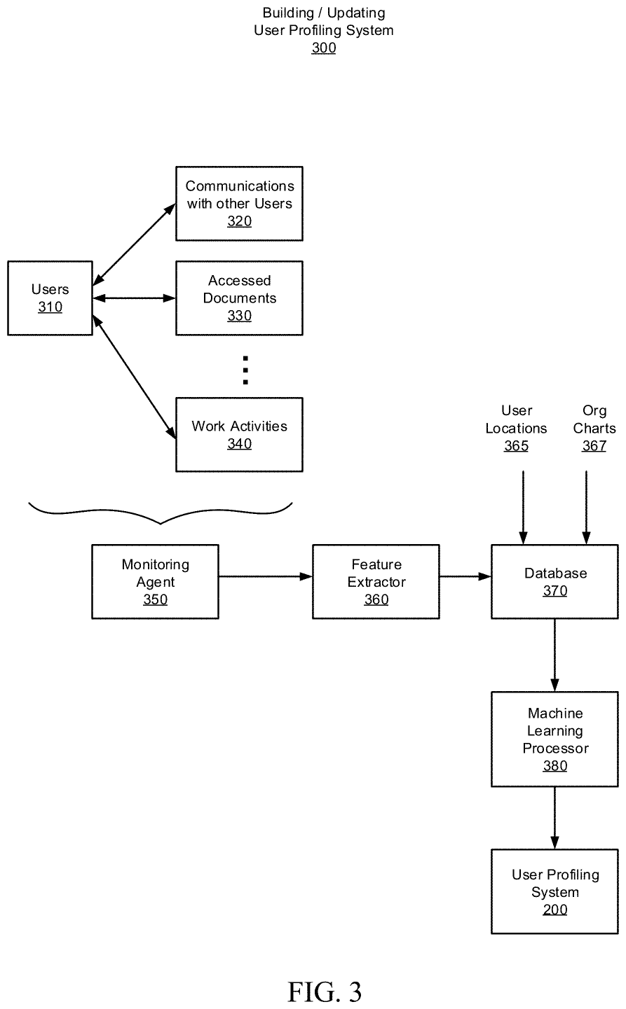

The profile query processor 220 is configured to accept a request 120 from requestor 110 of FIG. 1. Requestor 110 may be designated as user X, and the request specifies the technical skills and other characteristics that the requestor seeks. The request 120 is provided to user profiling system 200 which is configured to identify a target user Y 230 that meets (or most nearly meets) the requirements. In some examples, user profiling system 200 may also provide preferred communication channels of the target user. In some examples, multiple such target users may be identified. The operation of user profiling system 200 will be explained in greater detail below in connection with FIG. 3.

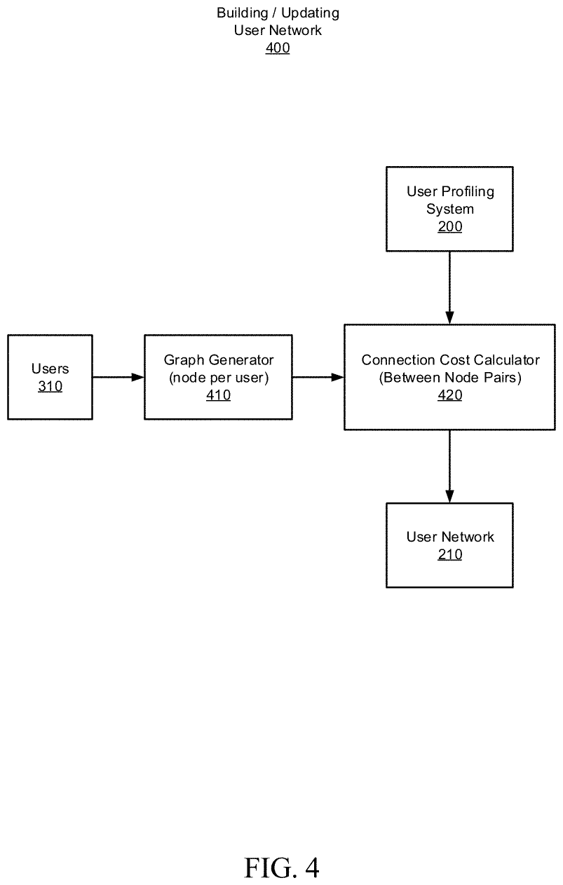

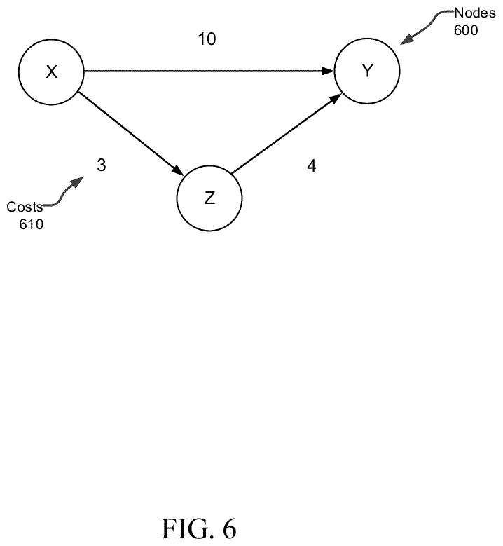

The minimum cost pathfinder 240 is configured to identify a minimum cost path between user X 110 and user Y 230, through the user network 210. The user network 210 is configured to model the users in the workspace 130 of FIG. 1 as a graph of nodes and links. Each node represents a user and the links between nodes specify a connection cost which describes how closely the two nodes (users) are connected or related. The connection cost calculation will be explained in greater detail below in connection with FIG. 4. A minimum cost path may be a direct path between user X and user Y, or it may be a more complex path through one or more intermediary users, for example if user X and user Y are not closely connected. This is illustrated in FIG. 6, which shows three nodes 600, one for each of users X, Y, and Z, along with connection costs 610. The connection cost for the direct link between user X and user Y is 10, the cost between user X and user Z is 3, and the cost between user Z and user Y is 4. As can be seen in this simple example, the direct link between X and Y has a higher cost (10) than a path going through user Z (cost=3+4). In a more complex network, however, finding the minimum cost path can be nontrivial. In some examples, the minimum cost path through a graph network may be calculated using the Dijkstra technique, or any suitable process in light of the present disclosure.

The recommendation generator 250 is configured to generate a recommendation, or recommendations, 150 of FIG. 1, based on the results provided by user profiling system 200 and minimum cost pathfinder 240.

FIG. 3 illustrates building and updating 300 of the user profiling system 200 of FIG. 2, in accordance with an example of the present disclosure. The process of building/updating the user profiling system 200 is shown to include a monitoring agent 350, a feature extractor 360, a database 370, and a machine learning processor 380.

The monitoring agent 350 is configured to monitor the activities of the users 310 of the workspace 130 of FIG. 1. These activities may include, but are not limited to, communications 320 with other users, documents that are generated or accessed 330, presentation given, meetings attended, and other work activities 340. Work activities may include projects that the users work on, tools and applications that the users employ, web pages that the user visits, and the like.

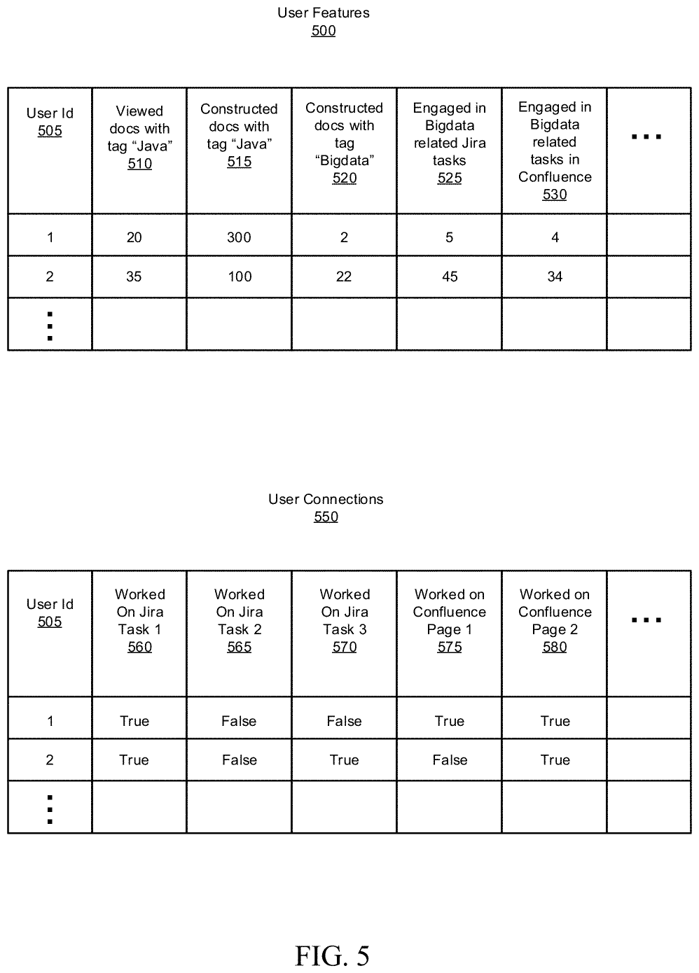

The feature extractor 360 is configured to extract user features from the monitoring results. This is illustrated, for example, in table 500 of FIG. 5. For each user, identified by user ID 505, features are quantified and tabulated as shown. These features may include, for example, the number of documents tagged with the keyword “Java” that have been viewed 510 by the user, the number of documents tagged with the keyword “Java” that have been constructed 515 by the user, the number of documents tagged with the keyword “Bigdata” 520 that have been viewed by the user, the number of Bigdata related Jira tasks 525 that have been engaged in by the user, and the number of Bigdata related tasks in Confluence 530 that have been engaged in by the user, to name just a few. In some examples, the extracted features may include involvement in cross-team assignments, and from this, a willingness to share information may be inferred as another user feature. From these features 500, a profile of the skills and interests of the users may be formed. In some examples, features may be weighted over time so that older activities, which may have less relevance, will have less impact on the user profile than more recent activities.

The database 370 is configured to store the extracted features 500. In some examples, the database 370 is also configured to store physical location information 365 of the users. In some examples, the database 370 is also configured to store information distilled from organizational charts that provide the location of the user (and their relationship to other users) within the organization's hierarchy.

The machine learning processor 380 is configured to generate the user profiling system 200. In some example, the machine learning processor 380 may employ data mining or other machine learning techniques to the data stored in database 370 to generate the user profiling system 200. In some examples the machine learning processor 380 may employ a supervised learning technique such as Random Forest classification. In some examples the machine learning processor 380 may employ an unsupervised learning technique such as K-means clustering, although any suitable technique may be used in light of the present disclosure.

FIG. 4 illustrates building and updating 400 of the user network 210 of FIG. 2, in accordance with an example of the present disclosure. The process of building/updating the user network 210 is shown to include a graph generator 410 and a connection cost calculator 420.

The graph generator 410 is configured to generate a network graph comprising nodes and links. Each node is associated one of the users 310 of FIG. 3. Each node may be connected or linked to any suitable number of other nodes, depending on the desired complexity of the graph. For example, a complete network graph would link every user in the organization to every other user, but this would likely be impractically complex for a large organization. An alternative approach would be to link users to a reduced number of other relatively local users.

The connection cost calculator 420 is configured to calculate connection costs between nodes and assign those costs to the associated link. In some examples the cost is based on three factors: spatial or physical distance between users (designated D); measure of a working relationship between the users (designated R); and measure of messaging frequency between the users (designated F). These factors may be estimated empirically. In some examples, they may be estimated as follows.

The spatial distance D may be set to 1 if the users are located in the same site (e.g., building or facility), or 2 if the users are located in different sites but the same country, or 3 if the users are located in different countries. These numbers are given as examples and may be modified based on experimental results.

Working relationship R between users may be initialized to zero and then increased by 1/N for every meeting of N people that the users jointly attend. R may also be increased by 1 if the users worked together on a document (e.g., a Confluence page) or worked on the same Jira issue, etc. If additional such work is jointly performed by the users within a given time period (e.g., 24 hours), R may be increased by an additional 0.1 for each occurrence up to a selected limit (e.g., three times). Once again, these numbers are given as examples and may be modified based on experimental results. This information may be gathered by the monitoring agent 350 of FIG. 3. This is illustrated, for example, in table 550 of FIG. 5, showing user connections. For each user, identified by user ID 505, the columns 560, . . . 580 indicate whether or not the user worked on a particular task, document, or other activity. The number of occurrences and the timings of the events are not shown in the table for simplicity but may be included in some examples. The working relationship R may also be increased for users that work in the same reporting organization, as determined for example from the organization chart.

Messaging frequency F between users may be based on the number of direct messages sent between the users (for example through a messaging application) relative to the total number of messages sent by the users to all people. Thus, in some examples, F=N/M, where N is the number of direct messages between the two users and M is the total number of messages sent by the users to all people. Messaging counts and messaging application usage may also be tracked by the monitoring agent 350.

In some example, the connection cost between users X and Y may then be calculated as:

$$Cost ( X , Y ) = \frac{D}{R + F}$$

Since the message application usage is being tracked, the recommendation(s) 150 of FIG. 1 can include the preferred communication channel (messaging application, email application, social networks, etc.) of the target user or any of the intermediate users. Use of the preferred communication channel by the requestor may improve the chance of getting a response from the target user.

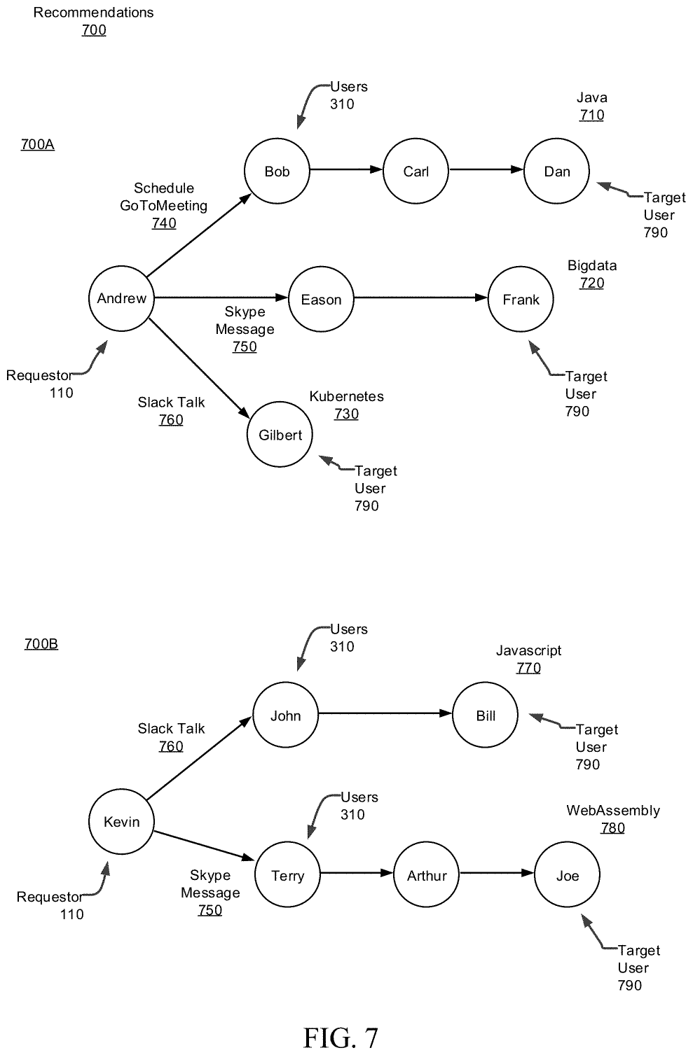

FIG. 7 illustrates recommendations 700 generated by the system 140 of FIG. 2, for connecting to people with requested skillsets, in accordance with an example of the present disclosure. In the example 700A, requestor Andrew is a chief technology officer initiating a new project that requires personnel with expertise in Java, Bigdata, and Kubernetes. The system 140 provides recommendations of Dan for Java 710, Frank for Bigdata 720, and Gilbert for Kubernetes 730. Based on the recommendation, Andrew could approach Gilbert directly using Slack Talk 760 as the most efficient communication channel for reaching Gilbert. The recommendation also suggests that Andrew build a connection to Dan through Bob and Carl as intermediaries, and a connection to Frank through Eason. Further, the recommendation also provides that the best way to reach Bob is to schedule a GoToMeeting 740, and the best way to reach Eason is via a Skype message 750. In some examples, these messaging applications may be a part of the computer network workspace 130 of FIG. 1.

In the example 700B, requestor Kevin is a manager whose team wants to introduce a new technology WebAssembly 780 along with Javascript performance tuning 770 into an ongoing project, but the current team members are not adequately experienced in this area. As such, it is hard for Kevin to put together a plan based on effort and risk estimation. The system 140 provides recommendations of Bill for Javascript 770, and Joe for WebAssembly 780. Based on the recommendation, Kevin can connect to Bill through John using Slack Talk 760 as the most efficient communication channel. The recommendation also suggests that Kevin build a connection to Joe through Terry and Arthur as intermediaries. Further, the recommendation provides that the best way to reach Terry is via a Skype message 750.

### Connection Process

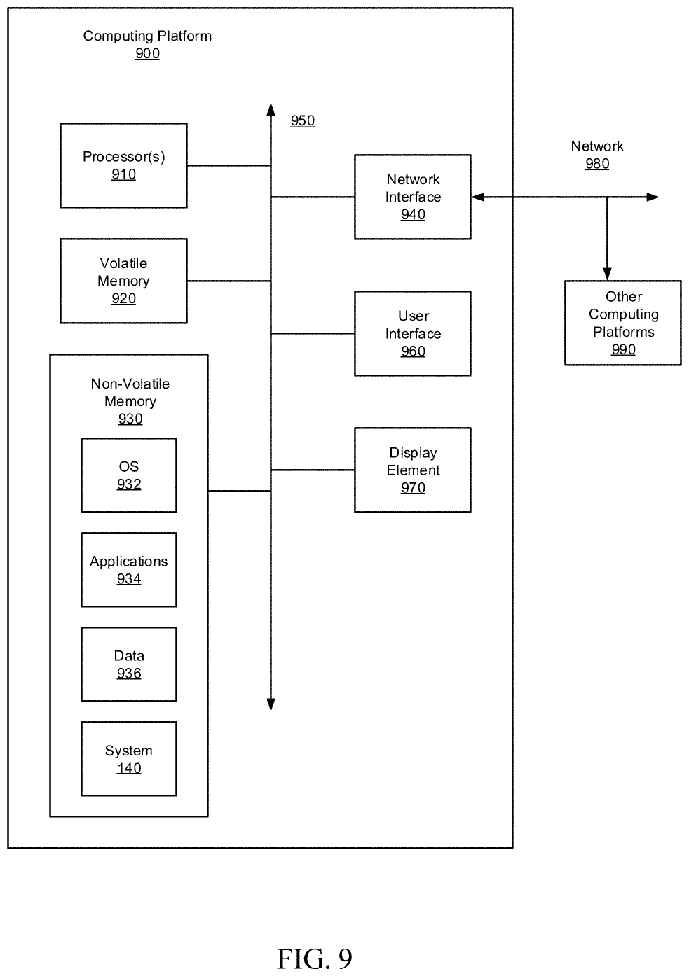

As described above, some examples of the system for connecting to people with requested skillsets 140 of FIG. 2 are configured to perform a process for providing a recommendation of one or more target users to a requestor, the target users possessing the desired skill sets, and the recommendation including a preferred channel for reaching the target users. The processes may be executed on a processor of any suitable type (e.g., processor 910 of FIG. 9).

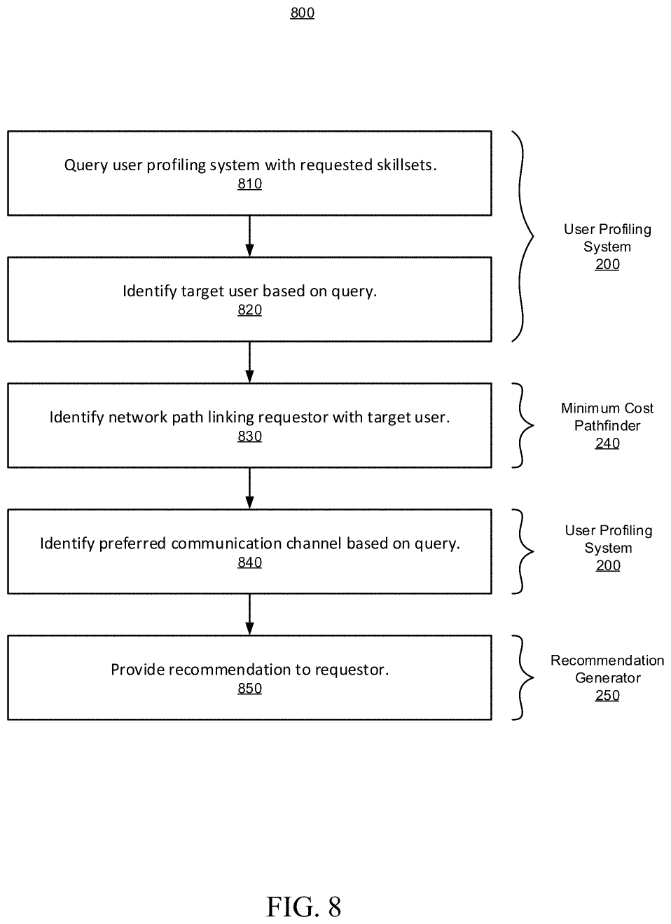

FIG. 8 is a flow diagram 800 of a process for connecting to people with requested skillsets, executed by any combination of profile query processor 220, minimum cost Pathfinder 240, and recommendation generator 250, of FIG. 2, in accordance with an example of the present disclosure.

The process 800 starts with querying 810, the user profiling system 200 of FIG. 2, with a skillset provided by a requestor. Next, at operation 820, a target user possessing the request skillset is identified by the user profiling system 200, based on results of the query.

At operation 830, a network path linking the requestor with the target user is identified by the minimum cost pathfinder 240 of FIG. 2, based on the user network 210 of FIG. 2. The network path comprises one or more links between nodes of the user network, wherein each node is associated with a user. The users include the requestor, the target user, and one or more other users which can serve as intermediaries for connecting the requestor to the target user.

At operation 830, a preferred communication channel associated with the target user (or other users such as the user who is closest to the requestor in the identified network path) is also identified by the user profiling system 200, based on the results of the query.

At operation 850, one or more recommendations are provided to the requester. The recommendations comprise the target user(s), the preferred communication channel(s), and the network path(s).

In some examples, monitoring is performed on one or more of communications between the users, communication methods employed by the users, documents accessed by the users, and work activities of the users, and a database is created from the user features extracted from the monitoring. The database may also include physical locations of the users and organization chart relationships between the users. Machine learning techniques are then applied to the database to generate the user profiling system. In some examples, the machine learning techniques may include Random Forest classification or K-means clustering.

In some examples, connectivity costs are calculated for the links of the user network. The connectivity costs may be based on one or more of a physical distance between the users, a measure of a working relationship between the users, and a measure of messaging frequency between the users.

The processes disclosed herein each depict one particular sequence of acts in a particular example. Some acts are optional and, as such, can be omitted in accord with one or more examples. Additionally, the order of acts can be altered, or other acts can be added, without departing from the scope of the apparatus and methods discussed herein.

Computing Platform for Connecting to People with Requested Skillsets

FIG. 9 is a block diagram of a computing platform 900 configured to perform a process for connecting to people with requested skillsets in accordance with an example of the present disclosure. In some cases, the platform 900 may be a workstation, laptop, mobile device, or smartphone.

The computing platform or device 900 includes one or more processors 910, volatile memory 920 (e.g., random access memory (RAM)), non-volatile memory 930, user interface (UI) 960, one or more network or communication interfaces 940, display element (e.g., screen) 970, and a communications bus 950. The computing platform 900 may also be referred to as a computer or a computer system.

The non-volatile (non-transitory) memory 930 can include: one or more hard disk drives (HDDs) or other magnetic or optical storage media; one or more solid state drives (SSDs), such as a flash drive or other solid-state storage media; one or more hybrid magnetic and solid-state drives; and/or one or more virtual storage volumes, such as a cloud storage, or a combination of such physical storage volumes and virtual storage volumes or arrays thereof.

The display element 970, can provide a graphical user interface (GUI) and in some cases, may be a touchscreen or any other suitable display device.

The user interface 960 can include one or more input/output (I/O) devices (e.g., a mouse, a keyboard, a microphone, one or more speakers, one or more biometric scanners, one or more environmental sensors, and one or more accelerometers, etc.).

The non-volatile memory 930 stores an operating system 932, one or more applications 934, data 936, and system for connecting to people with requested skillsets 140, such that, for example, computer instructions of the operating system 932, the applications 934, and the system 140, are executed by processor(s) 910 out of the volatile memory 920. In some examples, the volatile memory 920 can include one or more types of RAM and/or a cache memory that can offer a faster response time than a main memory. Data can be entered through the user interface 960. Various elements of the computer 900 can communicate via the communications bus 950.

The illustrated computing platform 900 is shown merely as an example client device or server and can be implemented by any computing or processing environment with any type of machine or set of machines that can have suitable hardware and/or software capable of operating as described herein.

The processor(s) 910 can be implemented by one or more programmable processors to execute one or more executable instructions, such as a computer program, to perform the functions of the system. As used herein, the term “processor” describes circuitry that performs a function, an operation, or a sequence of operations. The function, operation, or sequence of operations can be hard coded into the circuitry or soft coded by way of instructions held in a memory device and executed by the circuitry. A processor can perform the function, operation, or sequence of operations using digital values and/or using analog signals.

In some examples, the processor can be embodied in one or more application specific integrated circuits (ASICs), microprocessors, digital signal processors (DSPs), graphics processing units (GPUs), microcontrollers, field programmable gate arrays (FPGAs), programmable logic arrays (PLAs), multicore processors, or general-purpose computers with associated memory.

The processor 910 can be analog, digital or mixed. In some examples, the processor 910 can be one or more physical processors, or one or more virtual (e.g., remotely located or cloud) processors. A processor including multiple processor cores and/or multiple processors can provide functionality for parallel, simultaneous execution of instructions or for parallel, simultaneous execution of one instruction on more than one piece of data.

The network interfaces 940 can include one or more interfaces to enable the computing platform 900 to access a computer network 980 such as a Local Area Network (LAN), a Wide Area Network (WAN), a Personal Area Network (PAN), or the Internet through a variety of wired and/or wireless connections, including cellular connections. In some examples, the network 980 may allow for communication with other computing platforms 990, to enable distributed computing.

In described examples, the computing platform 900 can execute an application on behalf of a user of a client device. For example, the computing platform 900 can execute one or more virtual machines managed by a hypervisor. Each virtual machine can provide an execution session within which applications execute on behalf of a user or a client device, such as a hosted desktop session. The computing platform 900 can also execute a terminal services session to provide a hosted desktop environment. The computing platform 900 can provide access to a remote computing environment including one or more applications, one or more desktop applications, and one or more desktop sessions in which one or more applications can execute.

Having thus described several aspects of at least one example, it is to be appreciated that various alterations, modifications, and improvements will readily occur to those skilled in the art. For instance, examples disclosed herein can also be used in other contexts. Such alterations, modifications, and improvements are intended to be part of this disclosure and are intended to be within the scope of the examples discussed herein. Accordingly, the foregoing description and drawings are by way of example only.

Also, the phraseology and terminology used herein is for the purpose of description and should not be regarded as limiting. Any references to examples, components, elements or acts of the systems and methods herein referred to in the singular can also embrace examples including a plurality, and any references in plural to any example, component, element or act herein can also embrace examples including only a singularity. References in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items. References to “or” can be construed as inclusive so that any terms described using “or” can indicate any of a single, more than one, and all of the described terms. In addition, in the event of inconsistent usages of terms between this document and documents incorporated herein by reference, the term usage in the incorporated references is supplementary to that of this document; for irreconcilable inconsistencies, the term usage in this document controls.

1. A computer system comprising:
a memory;
a screen; and
at least one processor coupled to the memory and configured to:
query a user profiling system with a skillset provided by a requestor;
identify a target user based on results of the query, the target user associated with the skillset;
identify a network path linking the requestor with the target user, the network path comprising one or more links between nodes of a user network, the nodes associated with users, the users including the requestor, the target user, and one or more other users;
identify a preferred communication channel associated with the target user and/or the one or more other users, based on the results of the query; and
provide a recommendation to the requester, the recommendation comprising the target user, the preferred communication channel, and the network path.

2. The computer system of claim 1, wherein the at least one processor is further configured to:
extract user features based on monitoring one or more of communications between the users, communication methods employed by the users, documents accessed by the users, and work activities of the users;
create a database of the extracted user features; and
apply machine learning techniques to the database to generate the user profiling system.

3. The computer system of claim 2, wherein the at least one processor is further configured to determine locations of the users for inclusion in the database and to determine organization chart relationships between the users for inclusion in the database.

4. The computer system of claim 2, wherein the machine learning techniques comprise Random Forest classification or K-means clustering.

5. The computer system of claim 1, wherein the at least one processor is further configured to calculate connectivity costs associated with the links of the user network.

6. The computer system of claim 5, wherein the at least one processor is further configured to calculate the connectivity costs based on one or more of a physical distance between the users, a measure of a working relationship between the users, and a measure of messaging frequency between the users.

7. The computer system of claim 6, wherein the at least one processor is further configured to identify the network path based on minimization of a sum of the connectivity costs associated with the links between the requestor and the target user.

8. A method of connecting to users with requested skills comprising:
querying, by a computer system, a user profiling system with a skillset provided by a requestor;
identifying, by the computer system, a target user based on results of the query, the target user associated with the skillset;
identifying, by the computer system, a network path linking the requestor with the target user, the network path comprising one or more links between nodes of a user network, the nodes associated with users, the users including the requestor, the target user, and one or more other users;
identifying, by the computer system, a preferred communication channel associated with the target user and/or the one or more other users, based on the results of the query; and
providing, by the computer system, a recommendation to the requester, the recommendation comprising the target user, the preferred communication channel, and the network path.

9. The method of claim 8, further comprising:
extracting user features based on monitoring one or more of communications between the users, communication methods employed by the users, documents accessed by the users, and work activities of the users;
creating a database of the extracted user features; and
applying machine learning techniques to the database to generate the user profiling system.

10. The method of claim 9, further comprising determining locations of the users for inclusion in the database and determining organization chart relationships between the users for inclusion in the database.

11. The method of claim 9, wherein the machine learning techniques comprise Random Forest classification or K-means clustering.

12. The method of claim 8, further comprising calculating connectivity costs associated with the links of the user network.

13. The method of claim 12, further comprising calculating calculate the connectivity costs based on one or more of a physical distance between the users, a measure of a working relationship between the users, and a measure of messaging frequency between the users.

14. The method of claim 12, further comprising identifying the network path based on minimization of a sum of the connectivity costs associated with the links between the requestor and the target user.

15. A non-transitory computer readable medium storing executable sequences of instructions to connect to users with requested skills, the sequences of instructions comprising instructions to:
query a user profiling system with a skillset provided by a requestor;
identify a target user based on results of the query, the target user associated with the skillset;
identify a network path linking the requestor with the target user, the network path comprising one or more links between nodes of a user network, the nodes associated with users, the users including the requestor, the target user, and one or more other users;
identify a preferred communication channel associated with the target user and/or the one or more other users, based on the results of the query; and
provide a recommendation to the requester, the recommendation comprising the target user, the preferred communication channel, and the network path.

16. The computer readable medium of claim 15, wherein the sequences of instructions further include instructions to:
extract user features based on monitoring one or more of communications between the users, communication methods employed by the users, documents accessed by the users, and work activities of the users;
create a database of the extracted user features; and
apply machine learning techniques to the database to generate the user profiling system.

17. The computer readable medium of claim 16, wherein the sequences of instructions further include instructions to determine locations of the users for inclusion in the database and to determine organization chart relationships between the users for inclusion in the database.

18. The computer readable medium of claim 16, wherein the machine learning techniques comprise Random Forest classification or K-means clustering.

19. The computer readable medium of claim 15, wherein the sequences of instructions further include instructions to calculate connectivity costs associated with the links of the user network.

20. The computer readable medium of claim 19, wherein the sequences of instructions further include instructions to calculate the connectivity costs based on one or more of a physical distance between the users, a measure of a working relationship between the users, and a measure of messaging frequency between the users.

21. The computer readable medium of claim 19, wherein the sequences of instructions further include instructions to identify the network path based on minimization of a sum of the connectivity costs associated with the links between the requestor and the target user.
